(19) United States
(12) Patent Application Publication
(10) Pub. No.: US 2014/0348311 A1
(43) Pub. Date: Nov. 27, 2014

(54) INFORMATION BROADCASTING SYSTEM AND METHOD

(71) Applicant: HON HAI PRECISION INDUSTRY CO., LTD., New Taipei (TW)

(72) Inventor: Ting-She CHANG, New Taipei (TW)

(73) Assignee: HON HAI PRECISION INDUSTRY CO., LTD., New Taipei (TW)

(21) Appl. No.: 14/016,240

(22) Filed: Sep. 3, 2013

(30) Foreign Application Priority Data
May 22, 2013 (CN) 2013101917691

(51) Int. Cl. H04M 3/493

(52) U.S. Cl. CPC H04M 3/493
USPC 379/88.18

(57) ABSTRACT

An electronic device with a voice self-service function includes an input unit, a storage unit, and a processor. The storage unit stores a plurality of predetermined commercial service numbers, and service information associated with each predetermined commercial service number. The processor determines whether or not a number received by the input unit is one of the plurality of predetermined commercial service numbers, acquires the service information associated with the received number when the received number is one of the plurality of predetermined commercial service numbers, selects one or more pieces of the service information in response to a selection operation, and accesses the received number to give an access result. An information broadcasting system and a method are also provided.

### BACKGROUND

1. Technical Field

The present disclosure relates to service systems, and particularly to a system and a method to access service information.

2. Description of Related Art

Commercial service numbers can provide information for uses when the users dial the numbers. When a user dials a commercial service number, the server broadcasts a recorded voice for instructing the user to input corresponding information associated with the service information. However, although the above method can acquire the service information from the commercial service number, it is complex and time-consuming for the user to follow the recorded voice instructions.

Therefore, what is needed is an information broadcasting system to overcome the above described limitations.

### BRIEF DESCRIPTION OF THE DRAWING

FIG. 1 is a block diagram of an information broadcasting system in accordance with an exemplary embodiment.

FIG. 2 is a flowchart of an information broadcasting method implemented by the information broadcasting system of FIG. 1.

### DETAILED DESCRIPTION

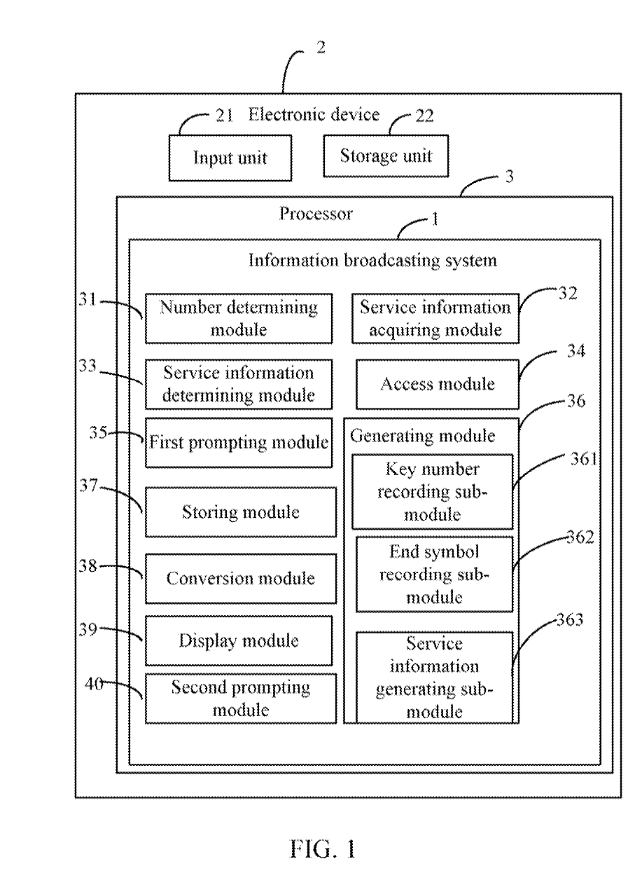

FIG. 1 shows an information broadcasting system 1 (hereinafter “system”). The system 1 runs in an electronic device 2. The electronic device 2 can be a mobile phone, a self-service system, or the like.

The electronic device 2 includes an input unit 21, a storage unit 22, and a processor 3. The input unit 21 receives user operations. The storage unit 22 stores a number of predetermined commercial service numbers and service information associated with each predetermined commercial service number. The service information associated with each predetermined service number is related to key number and end symbol inputted by a user. The end symbol indicates that the key number is finished being inputted by the user.

The processor 3 includes a collection of software instructions executed by the processor 3. The collection of software instructions includes a number determining module 31, a service information acquiring module 32, a service information determining module 33, an access module 34, a first prompting module 35, a generating module 36, and a storing module 37.

The number determining module 31 determines whether or not a number received by the input unit 21 is one of the predetermined commercial service numbers. The service information acquiring module 32 acquires the service information associated with the received number if the number received by the input unit 21 is one of the predetermined commercial service numbers. The service information determining module 33 selects one or more pieces of the service information in response to a selection operation. The access module 34 accesses the number based on the key number and the end symbol related to the selected service information to give an access result to the user.

For example, if the user dials the number “10086”, and the number “10086” is not a predetermined commercial service number, the server will broadcast a recorded voice to instruct the user to input. For example, the voice instructs that if the user wants to acquire the weather in Shenzhen in Chinese, the user must input key number “1” and end symbol “@” to represent “Chinese,” key number “2” and end symbol “%” to represent “weather,” and key number “0” and end symbol “*” to represent “Shenzhen,”. If the user inputs key number “1” and end symbol “@” to represent “Chinese,” key number “2” and end symbol “%” to represent “weather,” and key number “0” and end symbol “*” to represent “Shenzhen,” the server will tell the user the weather in Shenzhen in Chinese. That is, if the user wants to acquire the weather in Shenzhen in Chinese, the user must dial the service number “10086” and input “1@2%0*”, it is time-consuming for the user. However, if the user dials the number “10086”, and the number “10086” is a predetermined commercial service number, the service information acquiring module 32 acquires service information for the user. The service information determining module 33 selects one or more pieces of the service information in response to the selection operation. The service information includes the key number and end symbol “1@2%0*”. The access module 34 gives the access result to the user based on the selected service information. That is, it is only need the user to dial the number “10086”, and select one or more pieces of service information, instead of inputting the key number and end symbol in prior art, thereby saving time for the user.

The first prompting module 35 prompts whether or not to set the service information for the received number when the number received by the input unit 21 is not one of the predetermined commercial service numbers. The generating module 36 generates the service information for the received number when the user selects to set the service information for the received number. The storing module 37 stores the received number and the service information associated with the received number in the storage unit 22.

In one embodiment, the generating module 36 includes a key number recording sub-module 361, an end symbol recording sub-module 362, and a service information generating sub-module 363. The key number recording sub-module 361 records the key number inputted by the user when the received number is connected. The end symbol recording sub-module 362 records the end symbol inputted by the user when the received number is connected. The service information generating sub-module 363 generates the service information according to the recorded key number and the end symbol associated with each step.

For example, if the user calls the number “10086” and the number “10086” is not one of the predetermined commercial service numbers, the system 1 will prompt whether or not to set the service information for the number “10086”. If yes, the electronic device 2 will broadcast instructions for the user to input the key number and end symbol. For example, if the key number is “1” and the end symbol is “@”, to represent “Chinese service”; and if the key number is “2” and the end symbol is “#”, to represent “English service”, then the system 1 will record the key number and the end symbol to generate to a Chinese service and an English service for the number “10086”.

The processor 3 further includes a conversion module 38 and a display module 39 which are a collection of software instructions. The conversion module 38 converts the access result into text when the access result is broadcasted by the voice. The display module 39 displays the text.

The processor 3 further includes a second prompting module 40 which is a collection of software instructions. The second prompting module 40 further prompts the user when the access connects to an operator. In other embodiments, the second promoting module 40 can further prompt the user methods, such as playing music or vibrating.

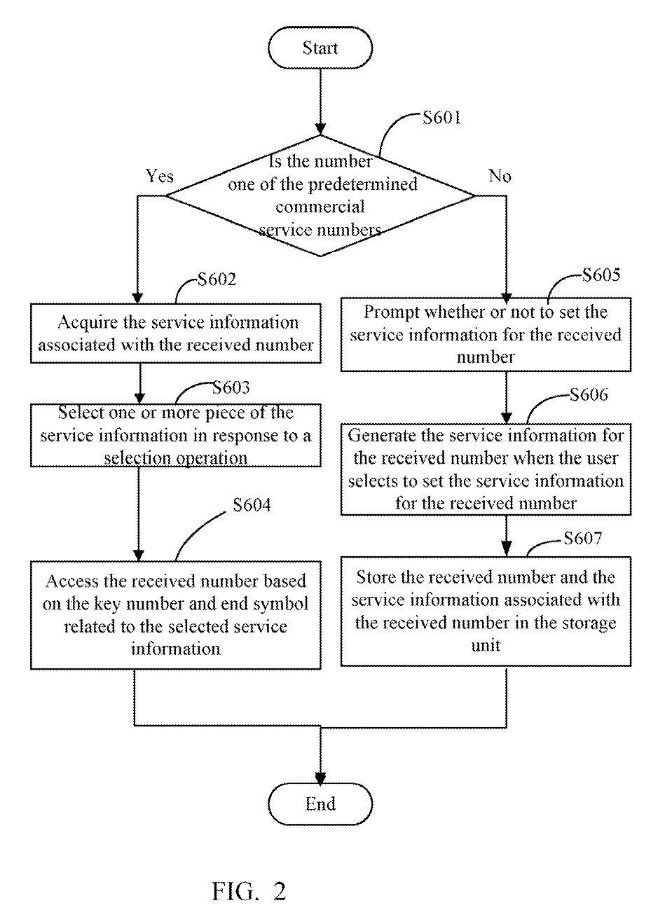

FIG. 2 is a flowchart of an information broadcasting method implemented by the information broadcasting system 1 of FIG. 1.

In step S601, the number determining module 31 determines whether or not a number received by the input unit 21 is one of the predetermined commercial service numbers, if yes, the procedure goes to step S602, if no, the procedure goes to step S605.

In step S602, the service information acquiring module 32 acquires the service information associated with the received number.

In step S603, the service information determining module 33 selects one or more of pieces the service information in response to a selection operation.

In step S604, the access module 34 accesses the received number based on the key number and the end symbol related to the selected service information to give an access result.

In step S605, the first prompting module 35 prompts whether or not to set the service information for the received number.

In step S606, the generating module 36 generates the service information for the received number when the user selects to set the service information for the received number.

In step S607, the storing module 37 stores the received number and the service information associated with the received number in the storage unit 22, and the procedure ends.

The method further includes sub-step: the conversion module 38 converts the access result into text when the access result is broadcasted by the voice, and the display module 39 displays the text.

The method further includes sub-step: the second prompting module 40 prompts the user when the access connects to an operator.

Although various embodiments have been specifically described, the disclosure is not to be construed as being limited thereto. Various changes or modifications may be made to the embodiments without departing from the scope and spirit of the disclosure.

What is claimed is:

1. An information broadcasting system running in an electronic device, wherein the electronic device comprises an input unit and a storage unit, the input unit is configured to receive user operation, the storage unit is configured to store a plurality of predetermined commercial service numbers, and service information associated with each of the plurality of predetermined commercial service numbers, each service information is related to key number and end symbol inputted by a user, the information broadcasting system comprising:
at least one processor; and
a plurality of modules to be executed by the at least one processor, wherein the plurality of modules comprises:
a number determining module configured to determine whether or not a number received by the input unit is one of the plurality of predetermined commercial service numbers;
a service information acquiring module configured to acquire the service information associated with the received number when the received number is one of the plurality of predetermined commercial service numbers;
a service information determining module configured to select one or more pieces of the service information in response to a selection operation received by the input unit; and
an access module configured to access the received number based on the key number and end symbol related to the selected service information to give an access result.

2. The information broadcasting system as described in claim 1, wherein the plurality of modules further comprises:
a first prompting module configured to prompt whether or not to set the service information for the received number when the number received by the input unit is not one of the predetermined commercial service numbers;
a generating module configured to generate the service information for the received number when the user selects to set the service information for the received number; and
a storing module configured to store the received number and the service information associated with the received number in the storage unit.

3. The information broadcasting system as described in claim 2, wherein the generating module further comprises:
a key number recording sub-module configured to record the key number inputted by the user when the received number is connected;
an end symbol recording sub-module configured to record the end symbol inputted by the user when the received number is connected; and
a service information generating sub-module configured to generate the service information according to the recorded key number and the recorded end symbol.

4. The information broadcasting system as described in claim 1, wherein the plurality of modules further comprises:
a conversion module configured to convert the access result into text when the access result is broadcasted by the voice; and
a display module configured to display the text.

5. The information broadcasting system as described in claim 1, wherein the plurality of modules further comprises:
a second prompting module configured to prompt the user when the access connects to an operator.

6. An electronic device with a voice self-service function comprising:
an input unit configured to receive user operation;
a storage unit configured to store a plurality of predetermined commercial service numbers, and service information associated with each of the plurality of predetermined commercial service numbers, wherein each service information is related to key number and end symbol inputted by a user; and
a processor configured to determine whether or not a number received by the input unit is one of the plurality of predetermined commercial service numbers, acquire the service information associated with the received number when the received number is one of the plurality of predetermined commercial service numbers, select one or more pieces of the service information in response to a selection operation received by the input unit, and access the received number based on the key number and the end symbol related to the selected service information to give an access result.

7. The electronic device as described in claim 6, wherein the processor is further configured to prompt whether or not to set the service information for the received number when the number received by the input unit is not one of the predetermined commercial service numbers, generate the service information for the received number when the user selects to set the service information for the received number, and store the received number and the service information associated with the received number in the storage unit.

8. The electronic device as described in claim 7, wherein the processor is further configured to record the key number inputted by the user when the received number is connected, record the end symbol inputted by the user when the received number is connected, and generate the service information based on the recorded key number and the recorded end symbol.

9. The electronic device as described in claim 6, wherein the processor is further configured to convert the access result into text when the access result is broadcasted by the voice, and display the text.

10. The electronic device as described in claim 6, wherein the processor is further configured to prompt the user when the access connects to an operator.

11. An information broadcasting method running in an electronic device, wherein the electronic device comprises an input unit and a storage unit, the input unit is configured to receive user operation, the storage unit is configured to store a plurality of predetermined commercial service numbers, and service information associated with each of the plurality of predetermined commercial service numbers, each service information is related to key number and end symbol inputted by a user, the information broadcasting method comprising:
determining whether or not a number received by the input unit is one of the plurality of predetermined commercial service numbers;
acquiring the service information associated with the received number when the received number is one of the plurality of predetermined commercial service numbers;
selecting one or more pieces of the service information in response to a selection operation; and
accessing the received number based on the key number and the end symbol related to the selected service information to give an access result.

12. The information broadcasting method as described in claim 11, further comprising:
prompting whether or not to set the service information for the received number when the number received by the input unit is not one of the predetermined commercial service numbers;
generating the service information for the received number when the user selects to set the service information for the received number; and
storing the received number and the service information associated with the received number in the storage unit.

13. The information broadcasting method as described in claim 12, further comprising:
recording the key number inputted by the user when the received number is connected;
recording the end symbol inputted by the user when the received number is connected; and
generating the service information based on the recorded key number and the recorded end symbol.

14. The information broadcasting method as described in claim 11, further comprising:
converting the access result into text when the access result is broadcasted by the voice; and
displaying the text.

15. The information broadcasting method as described in claim 11, further comprising:
prompt the user when the access connects to an operator.
